(19) United States
(12) Patent Application Publication
(10) Pub. No.: US 2009/0308311 A1
(43) Pub. Date: Dec. 17, 2009

(54) Surface treatment system

(76) Inventors: Kersten Link, Grafenau (DE); Werner Swoboda, Boeblingen (DE)

Correspondence Address: FACTOR & LAKE, LTD, 1327 W. WASHINGTON BLVD., SUITE 5G/H, CHICAGO, IL, 60607, US

(21) Appl. No.: 11/918,758

(22) PCT Filed: Apr. 15, 2006
(86) PCT No.: PCT/EP2006/003496

§ 371 Date: Oct. 18, 2007

(30) Foreign Application Priority Data
Apr. 22, 2005 (DE) 10 2005 019 700.0

(51) Int. Cl. B05C 11/00

(52) U.S. Cl. 118/620

(57) ABSTRACT

A surface treatment system, particularly for painting, coating, drying and the associated preparation of metallic or nonmetallic objects, contains a circuit, in which a liquid is circulated. In order to sterilize the liquid, the invention provides that a device for mechanically/physically opening cell membranes is integrated in the circuit. The germs can be removed while not creating strains resistant to the sterilization.

The invention relates to a surface treatment system, in particular for carrying out the painting, coating, drying and associated preparation of metallic or nonmetallic articles, comprising a circuit in which a liquid is circulated.

Such surface treatment systems are generally known in the prior art. They serve to treat the surfaces of articles in various ways, for example by application of paints and other coatings. In general such systems comprise several individual treatment stations for different treatment steps, for example preparation, painting and drying. The articles to be treated, which may be not only metallic but also nonmetallic articles, are conveyed for this purpose from treatment station to treatment station with the assistance of a conveying system.

Relatively large quantities of liquid are often circulated in the individual treatment stations. The liquids are used, for example, for cleaning the stations, for degreasing or rinsing the articles or as a carrier for pigments. On cost and environmental grounds, these liquids are in general not disposed of after their first use, but instead circulated in a circuit and, in so doing, introduced into a reprocessing apparatus. The liquid is generally subjected to mechanical and physico-chemical cleaning in the reprocessing apparatus before being reused. In this way, once provided, liquid no longer has to be completely replaced. Replacement generally proceeds simply by introducing relatively small quantities of liquid continuously or at regular intervals to make up the losses of liquid due, for example, to removal of the liquid by the articles or by evaporation.

Due to the long residence time of the liquids in the circuits, microorganisms may multiply in the liquid. Microorganisms multiply particularly rapidly if the liquid is warm, as is frequently the case, for example, in cataphoretic dip coating. In the present connection, microorganisms are taken to mean not only bacteria and other unicellular organisms, but also fungi and algae.

If the multiplication of such microorganisms is not inhibited, they may cause serious harm to the health of operating personnel and may even make a system shutdown necessary. Microorganisms may particularly readily be transferred into the air when liquids are atomised, as occurs, for example, when cleaning spray booths.

There is furthermore a risk that the microorganisms will accumulate on surfaces and thereby clog filters or pipework with small diameters. If the microorganisms are deposited on the surfaces of the articles to be treated, the technical result may be impaired, for example resulting in coating blemishes. Since the microorganisms are transferred from station to station during conveying of the articles, there is also a risk that microorganisms will be introduced into zones in which multiplication per se is somewhat improbable due to unfavourable chemical or thermal conditions. For example, contamination of a paint dip tank by microorganisms may entail a very costly replacement of the liquid present in the tank.

Since high concentrations of microorganisms of more than 10⁸ microorganisms per cm³ may be established relatively quickly, biocides are mixed into the liquids for the purpose of sterilisation, said biocides being taken to mean bactericides and fungicides. While the bioactive toxic substances may indeed keep the concentration of microorganisms relatively low, the costs for this type of disinfection are high. Moreover, biocides are additives which may likewise impair the technical result of the treatment and which complicate biological treatment of wastewater. Another problem with using chemical/biological agents is the ability of many microorganisms to develop resistant strains, which can only be combatted, if at all, with new and thus particularly costly agents.

Against this background, it is an object of the present invention to improve a surface treatment system in such a manner that a reduction in the concentration of microorganisms in circulated liquids may simply and inexpensively be achieved.

This object is achieved according to the invention in that, for the purpose of disinfecting the liquid, an apparatus for mechanically opening cell membranes is incorporated into the circuit.

The microorganisms are thus not killed by chemical/biological means, but are instead subjected to such mechanical stress that the cell membranes open up irreversibly, which causes the cytoplasm to escape from the cells, bringing about their death. This type of disinfection has the advantage that, apart from killed biological material, no residues remain in the liquid, as is the case with biocide treatment. Furthermore, such mechanical destruction of the microorganisms can be carried out comparatively inexpensively and efficiently. Another advantage of this approach is that the microorganisms cannot escape from what is ultimately mechanical sterilisation by producing resistant strains as is the case with chemical/biological sterilization using biocides. Finally, mechanical opening of cell membranes is also effective for disinfection purposes when the liquid is cloudy or contains highly absorbent pigments. This is a significant advantage relative to irradiation with short wavelength electromagnetic radiation, for example UV light, which has previously also been used for disinfection.

The apparatus for mechanically opening cell membranes may, for example, comprise an electroporation apparatus. The term “electroporation” denotes a method in which the cells are exposed to strong electrical fields for a short time. Ultrafine pores which are already present in the cell membrane are widened under the influence of the electrical field in such a manner that they do not reclose once the electrical field has subsided. The only requirement for this purpose is that the electrical field has a sufficient field strength and lasts for more than a certain minimum duration.

This method of killing biological cells is known per se from a paper by H. Bluhm et al. entitled “Aufschluβ und Abtötung biologischer Zellen mit Hilfe starker gepulster elektrische Felder [maceration and killing of biological cells with the assistance of strong pulsed electrical fields]”, Nachrichten—Forschungszentrum Karlsruhe, vol. 35, 3/2003, page 105 to 110. The focus in sterilisation has hitherto been on the purification of wastewater from effluent treatment plants, as for example described in U.S. 2002/0144957 A1. However, killing bacteria and other micro-organisms by electroporation is more difficult than opening plant cells, as is used for example in industrial juice extractors.

The inventors have discovered that the difficulties which have been described in the electroporation of biological wastewater do not occur or occur only to a limited extent in surface treatment systems. This is for example because only relatively small quantities of biological material are introduced from the outside into the surface stations. Above all, however, the liquids are circulated relatively frequently, such that even comparatively low disinfection rates are sufficient to keep the concentration of microorganisms at a very low level.

Instead of an electroporation apparatus, it is also possible to use a cavitation apparatus which accelerates the liquid in such a manner that pressure pulses caused by cavitation open the cell membranes. The term cavitation is taken to mean the formation of gas-filled cavities in liquids in reduced pressure zones as are, for example, formed when the instantaneous local pressure drops below the vapour pressure of the liquid. If, on acceleration of a flowing liquid, the pressure drops below the vapour pressure, vapour bubbles are formed which implode and collapse when the pressure rises. The associated sudden change in volume may generate pressure pulses of up to 10,000 bar which destroy the cell membranes.

In order to produce cavitation, the static pressure of the liquid must be reduced. This may be achieved by accelerating the liquid, as for example occurs when the liquid passes through a narrowing. Acceleration may also be achieved by contact with rapidly moving parts, for example a pump rotor.

The circuit may in particular comprise part of a reprocessing apparatus for reprocessing the liquid. The reprocessing apparatus may in turn be assigned to one or more processing stations. Warm rinsing liquids in which microorganisms find good conditions for multiplication are frequently used in pretreatment stations, for example a degreasing station or a spray or dip rinsing station. Reprocessing apparatus for regenerating circulated liquids, specifically both paints and paint rinsing water, is most generally also provided in dip or spray painting stations downstream from pretreatment. A relatively high temperature likewise prevails, for example, in a cataphoretic dip coating bath and microbial attack of the bath contents is particularly critical because replacing paints causes considerable costs.

Further features and advantages of the invention are revealed by the following description of an exemplary embodiment made with reference to the drawings, in which:

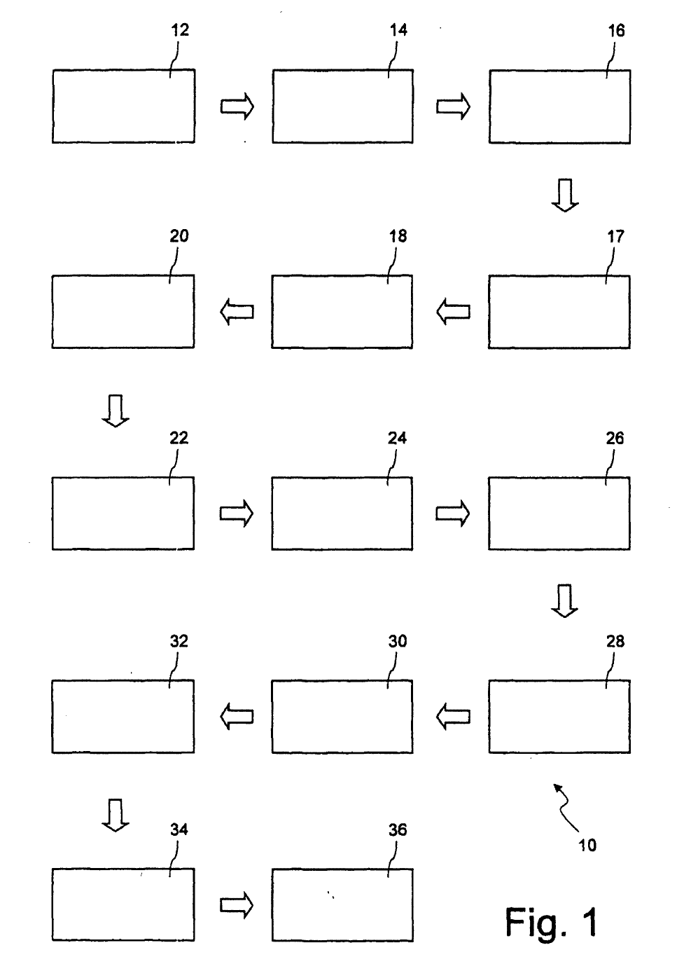

FIG. 1 is a block diagram of a pretreatment zone of a coating line;

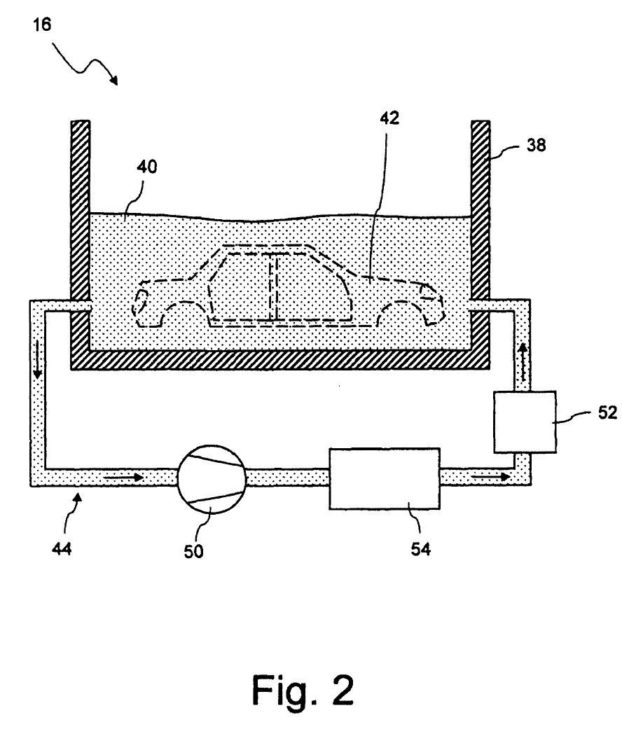

FIG. 2 shows a schematic longitudinal section of a dip degreasing station of the pretreatment zone shown in FIG. 1;

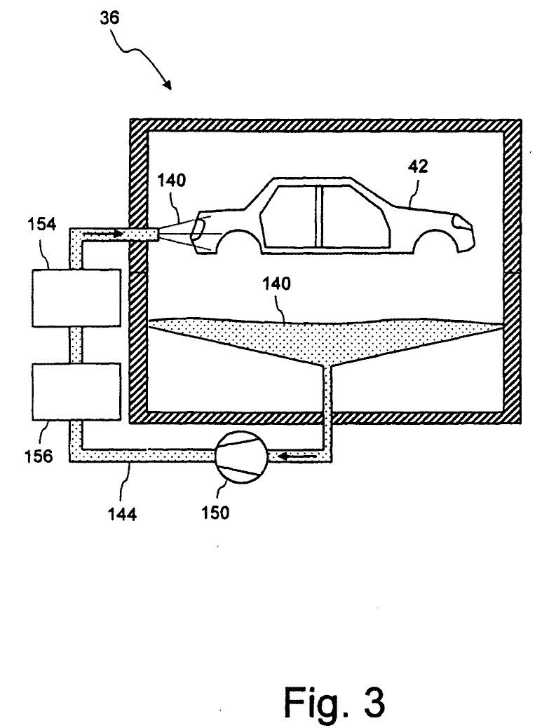

FIG. 3 shows a schematic longitudinal section of a spray rinsing station of the pretreatment zone shown in FIG. 1;

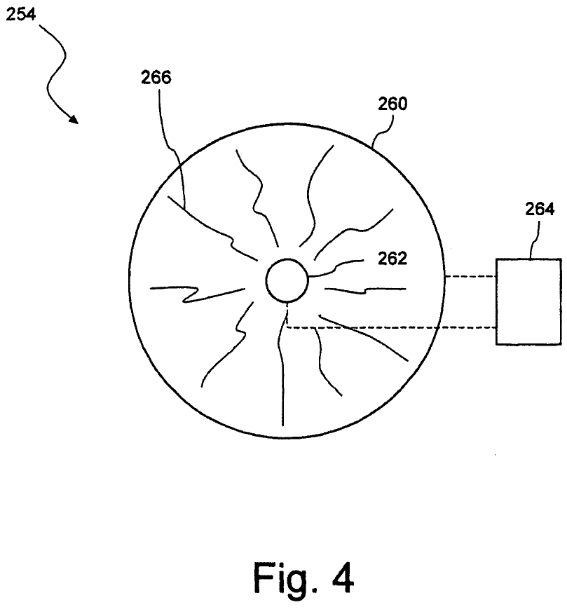

FIG. 4 shows a simplified cross-section through an electroporation apparatus in which a corona discharge is produced.

FIG. 1 shows, in the form of a block diagram, a pretreatment zone, designated 10 overall, of a coating line in which unfinished motor vehicle bodies are painted. It is assumed here that, with the assistance of a conveying system (not shown), the preassembled unfinished bodies are conveyed in the order indicated by arrows from station to station, where they are treated in different ways.

Since the sheet metal parts from which the unfinished bodies are manufactured are greased prior to pressing, the unfinished bodies are covered with a thin film of grease when they enter the pretreatment zone 10. Three stations 12, 14 and 16 are provided for degreasing the unfinished bodies, in which degreasing by flooding, spraying or dipping is carried out in a manner known per se.

The degreasing stations 12, 14, 16 are followed by two rinsing stations 17, 18. Dip activation or zinc phosphating takes place in stations 20 and 22. There then follow three stations 24, 26, 28, in which the unfinished bodies are rinsed with deionised water. Cataphoretic dip coating takes place in the painting station 30, where the unfinished body is dipped into a paint bath and coated in an electrical field. The painting station 30 is followed by two ultrafiltration rinsing stations 32, 34 and a spray rinsing station 36, in which the unfinished body is again cleaned with deionised water. This is the final step which completes pretreatment of the unfinished bodies in the pretreatment zone 10 of the coating line.

The unfinished bodies are then dried, spray painted, dried again and optionally subjected to further treatment, before they leave the coating line.

FIG. 2 shows a schematic longitudinal section of the dip degreasing station 16. The dip degreasing station 16 comprises a dip tank 38 which is filled with heated water 40. The water 40 contains added detergents which assist in dissolving away any traces of grease from an immersed unfinished body 42. The water 40 is continuously circulated via a circuit 44 with the assistance of a pump 50, as indicated by the arrows. In so doing, the water 40 passes through a heating unit 52 which heats the water 40. Further units may also be incorporated into the circuit 44. Such units which may be considered are for example filter elements or feed devices with which it is possible to add a detergent or water to replace water removed from the dip tank 38 by the unfinished bodies 42.

Bacteria and other microorganisms find favourable conditions for rapid multiplication in the water 40, which is warm and contains traces of grease. Such microorganisms may be conveyed together with the bodies 42 into downstream treatment stations where the microorganisms may, under certain circumstances, multiply further.

If the concentration of microorganisms exceeds a certain order of magnitude, the microorganisms may block small orifices in filters or the like or pipework with a small cross-section, thereby causing malfunctions. There is furthermore a risk that the microorganisms will settle on the unfinished body 42 and impair the treatment result.

After treatment in the dip tank 38, the unfinished body 42 is lifted out of the water 40, so bringing the unfinished body 42 into contact with ambient air. In this way, micro-organisms located on the unfinished body 42 may pass into the air and cause harm to the health of operating personnel. Particularly hazardous pathogens, such as for example legionella, may even make it necessary to shut the entire coating line down.

In order to reduce these risks and harm, an electroporation apparatus 54 is incorporated into the circuit 44 in order to disinfect the water 40. In the exemplary embodiment shown in FIG. 2, the electroporation apparatus 54 is located between the pump 50 and the heating unit 52. The electroporation apparatus 54 may, however, also be arranged at another point, for example (in the direction of flow) upstream of the pump 50, downstream of the heating unit 52 or in a bypass line (optionally specifically provided for this purpose).

Electroporation apparatuses suitable for this purpose are known per se from the prior art. Reference is made in this connection to the above-mentioned paper by H. Bluhm et al. and to DE 101 44 486 C1. Parameters which are selectable during electroporation, such as the amplitude, duration, frequency and shape of pulses, have an influence on the efficiency with which microorganisms are killed and should be adapted to the particular conditions. Since the water 40 is circulated continuously in the circuit 44, it is possible to modify one or more of these parameters during the period of operation of the coating line, thereby also making it possible to kill entirely different microorganisms.

Thanks to electroporation, the density of microorganisms in the water 40 supplied by the pump 50 may be reduced by several orders of magnitude. As a result of the continuous circulation, it is thus possible to keep the density of microorganisms to such a low level that neither impairment of the technical result nor health risks are to be anticipated.

Instead of the electroporation apparatus 54, it is also possible to provide a cavitation apparatus, in which the water 40 is subjected to severe acceleration for example at a narrowing in the pipework or with the assistance of an impeller or the like. The severe acceleration generates gas bubbles in the water 40, which, on collapsing, in turn generate strong pressure pulses. These pressure pulses at least partially open up the cell membranes of the microorganisms, thereby achieving an effect similar to that achieved in the electroporation apparatus.

Since all the stations shown in FIG. 1 use liquids, remove them from the actual treatment zone and reprocess them in a circuit, electroporation or cavitation apparatuses may also be used in them in the same way as has been explained above in relation to FIG. 2.

Representatively for these further stations, FIG. 3 shows a highly schematic longitudinal section of the spray rinsing station 36, in which the vehicle bodies are sprayed down with deionised water 140 following ultrafiltration rinsing in stations 32, 34. The water 140 collects at the bottom of the station 36 and is reprocessed in a circuit 144, in which the water 144 passes through a pump 150, a filtration and deionisation apparatus 156 and an electroporation apparatus 154, before being sprayed again onto the unfinished bodies 42.

FIG. 4 shows a cross-section through essential parts of an electroporation apparatus with which corona discharges may additionally be produced. In a first pipe 260 having a diameter d₁, there is arranged coaxially a second pipe 262 having a diameter d₂<d₁. The two pipes 260, 262 form the electrodes of the electroporation apparatus 254. The pipes 260, 262 are connected to a pulse generator 264 with which high voltage pulses may be generated.

When a liquid to be disinfected is flowing through the interspace between the two pipes 260, 262 and if sufficiently elevated field strengths are generated between the pipes 260, 262, corona discharges occur, as indicated by lines 266 in FIG. 4. The corona discharges 266 enhance the disinfection of the liquid flowing through the interspace. This is because the corona discharges 266 give rise to free radicals and other chemically aggressive substances such as for instance H₂O₂ in the liquid, which subject the microorganisms to chemical/biological attack.

1. A surface treatment system for carrying out the painting, coating, drying and associated preparation of metallic or nonmetallic articles, comprising a circuit in which a liquid is circulated, wherein
for the purposes of disinfecting the liquid, an apparatus for mechanically/physically opening cell membranes is incorporated into the circuit.

2. The surface treatment system of claim 1, wherein the apparatus is an electroporation apparatus.

3. The surface treatment system of claim 2, wherein the operating parameters of the electroporation apparatus may be modified during operation of the surface treatment system.

4. The surface treatment system of claim 2, wherein corona discharges can be generated in the electroporation apparatus.

5. The surface treatment system of claim 1, wherein the apparatus is a cavitation apparatus which accelerates the liquid in such a manner that pressure pulses brought about by cavitation open the cell membranes.

6. The surface treatment system of claim 1, wherein the circuit is part of a reprocessing apparatus for reprocessing the liquid.

7. The surface treatment system of claim 6, wherein the reprocessing apparatus is assigned to a cataphoretic dip coating station.

8. The surface treatment system of according to claim 6, wherein the reprocessing apparatus is assigned to one of the pretreatment stations upstream of painting.

9. The surface treatment system of claim 8, wherein the pretreatment station is a degreasing station.

10. The surface treatment system of claim 8, wherein the pretreatment station is a phosphating station.

11. The surface treatment system of claim 8, wherein the pretreatment station is a rinsing station.

12. The surface treatment system of claim 11, wherein rinsing is performed with deionised water in the rinsing station.

13. The surface treatment system of claim 6, wherein the reprocessing apparatus is assigned to a system for producing deionised water.

14. The surface treatment system of claim 6, wherein the reprocessing apparatus is assigned to a paint spraying station for spray application of paints.

15. The surface treatment system of claim 14, wherein paint rinsing water is reprocessed in the reprocessing apparatus.

16. The surface treatment system of claim 1, wherein the liquid is water or an aqueous solution.
